(19) United States
(12) Patent Application Publication
(10) Pub. No.: US 2018/0354861 A1
(43) Pub. Date: Dec. 13, 2018

(54) Ceramic Material Assembly For Use In Highly Corrosive Or Erosive Industrial Applications

(71) Applicant: COMPONENT RE-ENGINEERING COMPANY, INC., Santa Clara, CA (US)

(72) Inventors: Brent Elliot, Cupertino, CA (US); Dennis George Rex, Williams, OR (US); Tim Dyer, Oakland, CA (US)

(21) Appl. No.: 15/927,788

(22) Filed: Mar. 21, 2018

Related U.S. Application Data
(60) Provisional application No. 62/474,597, filed on Mar. 21, 2017.

(51) Int. Cl. C04B 37/00; E21B 43/26; B23K 1/19; B23K 35/28

(52) U.S. Cl. CPC C04B 37/003; E21B 43/26; B23K 1/19; B23K 35/286; B23K 2103/52; C04B 2237/343; C04B 2237/60; C04B 2237/84; C04B 2237/121

(57) ABSTRACT

A composite assembly of a relatively inexpensive ceramic, such as alumina, with a skin, or covering, of a high wear ceramic, such as sapphire, adapted to be used in industrial environments subjected to high levels of corrosion and/or erosion. The design life of the composite assembly may be significantly longer than previously used components. The composite assembly may have its ceramic pieces joined together with aluminum, such that the joint is not vulnerable to corrosive aspects to which the composite assembly may be exposed.

### CROSS-REFERENCE TO RELATED APPLICATIONS

This application claims priority to U.S. Provisional Patent Application No. 62/474,597 to Elliot et al., filed Mar. 21, 2017, which is hereby incorporated by reference in its entirety.

### FIELD OF THE INVENTION

This invention relates to corrosion resistant assemblies, namely ceramic assemblies with high wear materials on high wear surfaces.

### BRIEF DESCRIPTION OF THE DRAWINGS

FIGS. 1 is a drawing of a hydraulic pressure exchanging pump.

FIGS. 2 is a drawing of a worn rotor.

FIGS. 3 is a rotor shaft according to some embodiments of the present invention.

FIGS. 4 is an end view of an end cap according to some embodiments of the present invention.

FIG. 5 is a rotor underlying structure according to some embodiments of the present invention.

FIG. 6 is an end cap according to some embodiments of the present invention.

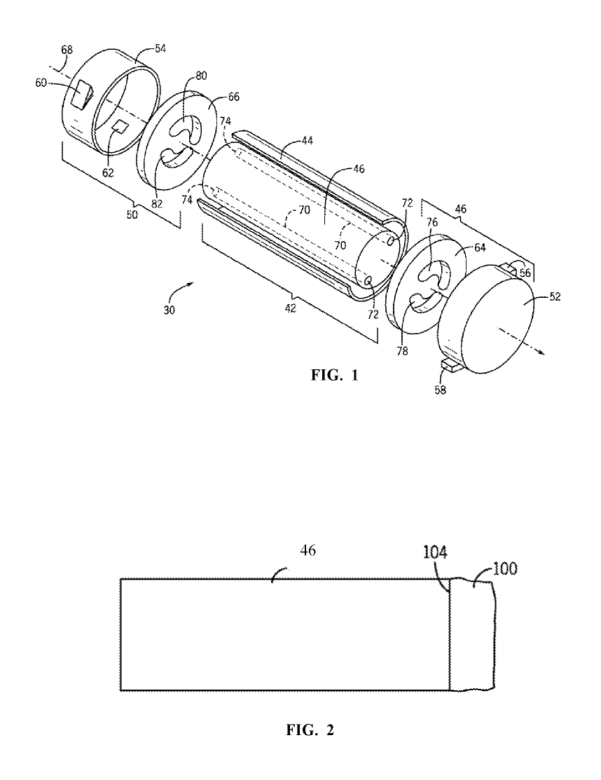

### SUMMARY

A composite assembly of a relatively inexpensive ceramic, such as alumina, with a skin, or covering, of a high wear ceramic, such as sapphire, adapted to be used in industrial environments subjected to high levels of corrosion and/or erosion. The design life of the composite assembly may be significantly longer than previously used components. The composite assembly may have its ceramic pieces joined together with aluminum, such that the joint is not vulnerable to corrosive aspects to which the composite assembly may be exposed.

### DETAILED DESCRIPTION

Well operations in the oil and gas industry may involve hydraulic fracturing (fracking) to increase the release of oil and gas in rock formations. Hydraulic fracturing involves pumping a fluid containing a combination of water, chemicals, and/or proppant into a well at high pressures. The high pressures of the fluid helps release more oil and gas, while the proppant prevents the cracks from closing once the fluid is depressurized. The proppant in the frac fluid may be abrasive and may increase the wear of the hydraulic fracturing equipment.

Hydraulic fracturing systems may include a hydraulic pressure exchanger system which may include rotating components which transfer pressure from a high pressure, less abrasive, fluid to a lower pressure, highly abrasive, fluid. The highly abrasive fluid may include sand, solid particles, and debris. The rotor and end covers of such a device are particularly susceptible to wear. The hydraulic pressure exchanger may be made of tungsten carbide in order to meet the wear demands, but this material is very expensive and also difficult to manufacture. Even with this wear resistant material, the components are subject to erosion and may need repair. An example of such a repair of a tungsten carbide system in seen in US 2016/0039054. The repair in that disclosure includes sawing off entire cross-sections of large components and replacing them.

An improved system for a hydraulic pressure exchanger is to cover high wear areas of components with a wear surface layer, or skin, of an extremely wear resistant material, such as sapphire. This approach may be used with a component that was previously made entirely, or in substantial part, of a high wear material which may only be needed in limited areas. A component made entirely, or in substantial part, of a high wear material may bring high cost that can be lowered with the approach as described herein. With the use of a high wear surface layer the bulk of the component can then be made of a less expensive and easier to manufacture material, such as alumina. A corrosion resistant joining layer may be used, such as aluminum. The surface layer may be brazed to the underlying structure in such a manner that a corrosion resistant, hermetic, joint is created. This system may also be used for other industrial components with identified high wear areas.

FIG. 2 is an exploded view of an embodiment of a rotary IPX 30. In the illustrated embodiment, the rotary IPX 30 may include a generally cylindrical body portion 42 that includes a housing 44 and a rotor 46. The rotary IPX 30 may also include two end structures 46 and 50 that may include manifolds 54 and 52, respectively. Manifold 52 includes inlet and outlet ports 58 and 56 and manifold 54 includes inlet and outlet ports 60 and 62. For example, inlet port 58 may receive a high-pressure first fluid and the outlet port 56 may be used to route a low-pressure first fluid away from the IPX 30. Similarly, inlet port 60 may receive a low-pressure second fluid and the outlet port 62 may be used to route a high-pressure second fluid away from the IPX 30. The end structures 46 and 50 include generally flat end plates (e.g., end covers) 66 and 64, respectively, disposed within the manifolds 50 and 46, and adapted for fluid sealing contact with the rotor 46. As noted above, one or more components of the IPX 30, such as the rotor 46, the end plate 66, and/or the end plate 64, may be constructed from a wear-resistant material (e.g., carbide, cemented carbide, silicon carbide, tungsten carbide, etc.) with a hardness greater than a predetermined threshold (e.g., a Vickers hardness number that is at least 1000, 1250, 1500, 1750, 2000, 2250, or more). For example, tungsten carbide may be more durable and may provide improved wear resistance to abrasive fluids as compared to other materials, such as alumina ceramics.

The rotor 46 may be cylindrical and disposed in the housing 44, and is arranged for rotation about a longitudinal axis 68 of the rotor 46. The rotor 46 may have a plurality of channels 70 extending substantially longitudinally through the rotor 46 with openings 74 and 72 at each end arranged symmetrically about the longitudinal axis 66. The openings 74 and 72 of the rotor 46 are arranged for hydraulic communication with the end plates 66 and 64 in such a manner that during rotation they alternately hydraulically expose fluid at high pressure and fluid at low pressure to the respective manifolds 54 and 52. The components at the end of this system which are in contact with the erosive fracking fluids are especially susceptible to wear. An example of such wear is seen in FIG. 2, with a wear area 120 along the end of the rotor 46.

In some embodiments of the present invention, a protective surface layer is joined to the underlying structure in an area of high exposure to erosive elements. In contrast to the aforementioned example which is made from tungsten carbide, a substitute rotor can be made utilizing a first ceramic for the underlying structure, and a second ceramic for a surface wear protection layer. In some aspects, the surface layer is sapphire. In some aspects, the underlying structure is alumina. This allows for the use of a ceramic for the underlying structure which is much easier to produce, such as alumina.

The sapphire surface layer may be affixed to the underlying structure in any suitable manner. In some aspects, the surface layer is attached to the underlying ceramic structure by a joining layer that is able to withstand corrosive processing chemistries. In some aspects, the corrosive processing chemistries are related to fracking chemicals. In some aspects, the joining layer is formed by a braze layer. In some aspects, the braze layer is an aluminum brazing layer. In some aspects, the surface layer, or skin, is comprised of a plurality of pieces which may overlay each other, or may have a labyrinth interface, or abut each other.

In some aspects, a sapphire surface layer is joined to an underlying ceramic structure by a joining braze layer at any suitable temperature. In some aspects, the temperature is at least 770C. In some aspects, the temperature is at least 800C. In some aspects, the temperature is less than 1200C. In some aspects, the temperature is between 770C and 1200C. In some aspects, the temperature is between 800C and 1200C. In some aspects, when using ceramics which may have material property degradation concerns at higher temperatures, the temperature used may be in the range of 770C to 1000C.

In some aspects, a sapphire surface layer is joined to an underlying ceramic structure by joining braze layer at any suitable temperature, including any of the temperatures disclosed herein, in a suitable environment. In some aspects, the environment is a nonoxygenated environment. In some aspects, the environment is free of oxygen. In some aspects, the environment is in the absence of oxygen. In some aspects, the environment is a vacuum. In some aspects, the environment is at a pressure lower than 1×10E-4 Torr. In some aspects, the environment is at a pressure lower than 1×10E-5 Torr. In some aspects, the environment is an argon (Ar) atmosphere. In some aspects, the environment is an atmosphere of other noble gasses. In some aspects, the environment is a hydrogen (H2) atmosphere.

In some aspects, a sapphire surface layer is joined to an underlying ceramic structure at any suitable temperature, including any of the temperatures disclosed herein, in a suitable environment, including any of the environments disclosed herein, by a braze layer. In some aspects, the braze layer is pure aluminum. In one embodiment, the braze layer is metallic aluminum of greater than 89% by weight. In some aspects, the braze layer has more than 89% aluminum by weight. In some aspects, the braze layer is metallic aluminum of greater than 99% by weight. In some aspects, the braze layer has more than 99% aluminum by weight.

In some aspects, a sapphire surface layer is joined to an underlying ceramic structure at any suitable temperature, including any of the temperatures disclosed herein, in a suitable environment, including any of the environments disclosed herein, by an aluminum joining layer, including an aluminum joining layer formed by any of the aluminum braze layers disclosed herein. In some aspects, the aluminum joining layer is free of diffusion bonding. In some aspects, the process of forming the aluminum joining layer is free of diffusion bonding. In some aspects, there is no diffusion bonding between the sapphire layer and the aluminum joining layer. In some aspects, the aluminum joining layer forms a hermetic seal between the sapphire surface layer and the ceramic structure. In some aspects, the aluminum joining layer forms a hermetic seal between the sapphire surface layer and the ceramic structure having a vacuum leak rate of <1×10E-9 sccm He/sec. In some aspects, the aluminum joining layer is able to withstand corrosive processing chemistries. In some aspects, the corrosive processing chemistries are fracking chemicals.

The underlying ceramic structure can be made from any suitable material, including aluminum nitride, aluminum oxide or alumina, sapphire, yttrium oxide, zirconia, and beryllium oxide.

As seen above, the thickness of the braze layer is adapted to be able to withstand the stresses due to the differential coefficients of thermal expansion between the various materials. Residual stresses may be incurred during the cool down from the brazing steps, which are described below. In addition, fast initial temperature ramping from room temperature may cause some temperature non-uniformity across the assembly, which may compound with the residual stresses incurred during brazing.

Aluminum has a property of forming a self-limiting layer of oxidized aluminum. This layer is generally homogenous, and, once formed, prevents or significantly limits additional oxygen or other oxidizing chemistries (such a fluorine chemistries) penetrating to the base aluminum and continuing the oxidation process. In this way, there is an initial brief period of oxidation or corrosion of the aluminum, which is then substantially stopped or slowed by the oxide (or fluoride) layer which has been formed on the surface of the aluminum. The braze material may be in the form of a foil sheet, a powder, a thin film, or be of any other form factor suitable for the brazing processes described herein. For example, the brazing layer may be a sheet having a thickness ranging from 0.00019 inches to 0.011 inches or more. In some embodiments, the braze material may be a sheet having a thickness of approximately 0.0012 inches. In some embodiments, the braze material may be a sheet having a thickness of approximately 0.006 inches. Typically, alloying constituents (such as magnesium, for example) in aluminum are formed as precipitates in between the grain boundaries of the aluminum. While they can reduce the oxidation resistance of the aluminum bonding layer, typically these precipitates do not form contiguous pathways through the aluminum, and thereby do not allow penetration of the oxidizing agents through the full aluminum layer, and thus leaving intact the self-limiting oxide-layer characteristic of aluminum which provides its corrosion resistance. In the embodiments using an aluminum alloy which contains constituents which can form precipitates, process parameters, including cooling protocols, would be adapted to minimize the precipitates in the grain boundary. For example, in some aspects, the braze material may be aluminum having a purity of at least 99.5%. In some embodiments, a commercially available aluminum foil, which may have a purity of greater than 92%, may be used. In some embodiments, alloys are used. These alloys may include Al-5w %Zr, Al-5w %Ti, commercial alloys #7005, #5083, and #7075. These alloys may be used with a joining temperature of 1100C in some embodiments. These alloys may be used with a temperature between 800C and 1200C in some embodiments. These alloys may be used with a lower or higher temperature in some embodiments. In some aspects, the joining layer braze material may be aluminum of greater than 99% by weight. In some aspects, the joining layer braze material may be aluminum of greater than 98% by weight.

The joining methods according to some embodiments of the present invention rely on control of wetting and flow of the joining material relative to the ceramic pieces to be joined. In some embodiments, the absence of oxygen during the joining process allows for proper wetting without reactions which change the materials in the joint area. With proper wetting and flow of the joining material, a hermetically sealed joint can be attained at a low temperature relative to liquid phase sintering, for example.

The presence of a significant amount of oxygen or nitrogen during the brazing process may create reactions which interfere with full wetting of the joint interface area, which in turn may result in a joint that is not hermetic. Without full wetting, non-wetted areas are introduced into the final joint, in the joint interface area. When sufficient contiguous non-wetted areas are introduced, the hermeticity of the joint is lost.

In some embodiments, the joining process is performed in a process chamber adapted to provide very low pressures. Joining processes according to embodiments of the present invention may require an absence of oxygen in order to achieve a hermetically sealed joint. In some embodiments, the process is performed at a pressure lower than 1×10E-4 Torr. In some embodiments, the process is performed at a pressure lower than 1×10E-5 Torr.

The presence of nitrogen may lead to the nitrogen reacting with the molten aluminum to form aluminum nitride, and this reaction formation may interfere with the wetting of the joint interface area. Similarly, the presence of oxygen may lead to the oxygen reacting with the molten aluminum to form aluminum oxide, and this reaction formation may interfere with the wetting of the joint interface area. Using a vacuum atmosphere of pressure lower than 5×10-5 Torr has been shown to have removed enough oxygen and nitrogen to allow for fully robust wetting of the joint interface area, and hermetic joints. In some embodiments, use of higher pressures, including atmospheric pressure, but using non-oxidizing gasses such as hydrogen or pure noble gasses such as argon, for example, in the process chamber during the brazing step has also led to robust wetting of the joint interface area, and hermetic joints. In order to avoid the oxygen reaction referred to above, the amount of oxygen in the process chamber during the brazing process must be low enough such that the full wetting of the joint interface area is not adversely affected. In order to avoid the nitrogen reaction referred to above, the amount of nitrogen present in the process chamber during the brazing process must be low enough such that the full wetting of j oint interface area is not adversely affected.

The selection of the proper atmosphere during the brazing process, coupled with maintaining a minimum joint thickness, may allow for the full wetting of the joint. Conversely, the selection of an improper atmosphere may lead to poor wetting, voids, and lead to a non-hermetic joint. The appropriate combination of controlled atmosphere and controlled joint thickness along with proper material selection and temperature during brazing allows for the joining of materials with hermetic joints.

In some aspects, the underlying structure ceramic is selected to present a close match in its coefficient of thermal expansion relative to the surface layer. Coefficients of thermal expansion may vary with temperature, so the selection of matching coefficients of thermal expansion should take into account the degree of match from room temperature, through the processing temperatures sought to be supported, and further through to the brazing temperature of the joining layer.

In an exemplary embodiment, the surface layer is sapphire, and the underlying structure is alumina. The coefficient of thermal expansion of sapphire (single crystal aluminum oxide) at 20C (293K), 517C (800K), and 1017C (1300K), respectively, is 5.38, 8.52, and 9.74×10E-6/K. The coefficient of thermal expansion of sintered alumina at 20C, 500C, and 1000C, respectively, is 4.6, 7.1, and 8.1×10E-6/K. These present a good match. In an exemplary embodiment, the brazing layer is aluminum with a purity of over 89%, and may be over 99% Al by weight.

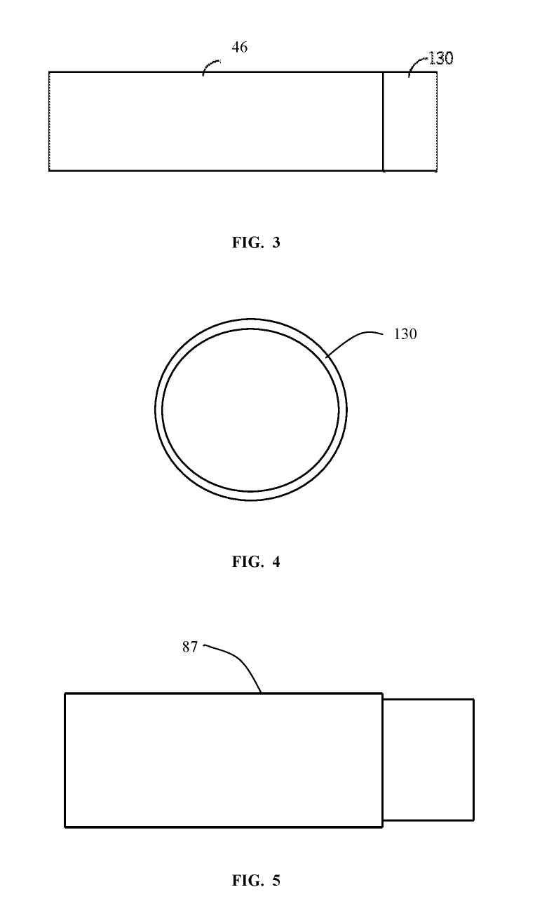

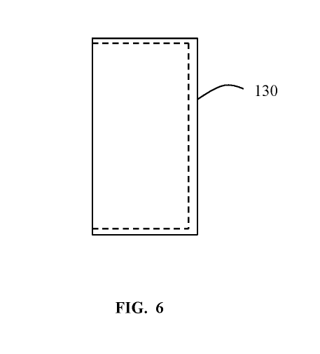

FIG. 3 illustrates a rotor 86 according to some embodiments of the present invention. The rotor 86 has an underlying structure 87 and an end cap 130. The underlying structure 87 may be of alumina and the end cap 130 may be of sapphire. The end cap 130 may be joined to the underlying structure 87 with an aluminum joining layer in accord with methods described above. The underlying structure 87 is cylindrical with a lessened diameter and the end which interfaces with the end cap 130. The end cap 130 is a cylinder with a circular end plate. With the use of the end cap 130 over the underlying structure 87, the rotor 86 may be manufactured using a more practical material, such as alumina, with even greater wear resistance than previously seen in other approaches.

In some aspects, an end sleeve may be used over the rotor. In some aspects, a circular end cap may be used with the rotor. In some aspects, an end sleeve and a circular end cap may be used with the rotor.

In another exemplary embodiment, the longitudinal channels 70 may be lined with cylindrical linings of a highly wear resistant material, such as sapphire. The sapphire cylindrical linings may be brazed to the underlying structure of the rotor according to joining methods described above.

The use of highly wear resistant surface layers, such as of sapphire, over an underlying structure of a more practical ceramic, such as alumina, provides a significant improvement over current approaches to components exposed to high wear erosive environments. The good thermal expansion match of sapphire to alumina affords a good pairing of materials.

The low temperature of the bonding process mentioned above enables use of Mg-PSZ, silicon nitride, and YTZ materials in addition to Sapphire. Current known process for bonding MgPSZ to other materials requires metallization at >1200C. During these processes at a temperature at or above 1200C, the toughening phase on the MgPSZ is degraded, with tetragonal zirconia forming cubic zirconia. Material is degraded by thermal overaging. A reason MgPSZ is a good material in high wear applications is due to the wear hardening effect of the abrasives on the material. As MgPSZ wears by abrasion, it develops a surface compressive stress from a phase transformation within the Zirconia. When scratched, the tetragonal zirconia collapses into monoclinic zirconia, and a volumetric expansion occurs in the Zirconia creating a compressive surface stress. This improves abrasion resistance of the ceramic. The processes according to the present invention may be only one that can bond MpPSZ to alumina without degrading the materials.

In some aspects, a method of designing and manufacturing components subjected to a highly erosive and/or highly corrosive operating environment includes utilizing hard materials such as advanced ceramics, metal-matrix-composites, and cermets in many industrial applications. The properties of these materials provide benefits in performance and lifetime in applications where corrosive, high temperature, and/or abrasive environments are present. However, another property of these materials is that in many cases they are difficult to join together. Typical methods currently in use to join these materials to themselves and to other materials include adhesives, glassing, active brazing, direct bonding, and diffusion bonding. All of these methods have limitations in either operating temperature, corrosion resistance, or joining materials of different thermal expansion coefficients. For example, adhesives cannot be used at elevated temperature, and have limited corrosion resistance. Active brazing has poor corrosion resistance; glasses have limited corrosion resistance and cannot tolerate any thermal expansion mismatch. Direct bonding and diffusion bonding also cannot tolerate any thermal expansion mismatch, as well as being expensive and difficult processes. Another characteristic of many of these materials is that they are difficult and costly to manufacture; by their very nature, they are extremely hard. Shaping them into required geometries can often require hundreds of hours of grinding with diamond tooling. Some of the strongest and hardest of these materials, for example sapphire and partially-stabilized zirconia (known as PSZ or ceramic steel), are so costly and difficult to work with that they have extremely limited industrial applications.

In mining and oil exploration, highly abrasive slurries must be pumped from underground. Similarly as fracking utilizes pressure exchange units to deliver high-pressure abrasive slurries, mining and oil exploration utilize a host of different apparatus for slurry pumping and transport. The internal components of these pumping systems are sometimes made from advanced ceramics such as alumina. With the use of PSZ in these applications, significant lifetime and performance advantages can result. Specific to PSZ, one of its material characteristics is extremely high internal stress—this is partly what provides its great strength and abrasion resistance. However, it makes manufacturing high-precision machine components very difficult (virtually impossible) as, due to the internal stresses, the material is not dimensionally stable. As you attempt to grind the correct shapes and dimensions, the material moves, so precise parts are not able to made from PSZ. What is needed is a method to utilize the properties of the best materials, in this case PSZ, with a cost near that of the current materials.

For example, with the abrasive slurry pumping applications in fracking, mining, and oil exploration, components such as rotors, bearings, end caps, etc. which are subject to wear due to abrasion of the slurry, the aforementioned process of aluminum brazing is utilized to join a “skin”, or wear surface layer, of PSZ or sapphire onto a structure of alumina. Utilizing this approach, the underlying alumina structure, to which the layer of PSZ is solidly joined, provides the dimensional stability required to achieve the necessary geometries. The PSZ provides the abrasion resistance performance where it is needed, and the manufacturability and costs of alumina are used to provide the bulk of the structure. Sapphire can also be used, although the cost increase of sapphire and the abrasion resistance of PSZ although make PSZ the better choice some cases. In other examples, components are made with tungsten carbide, an extremely hard ceramic material. Manufacturing such components is extremely expensive. Use of PSZ in locations shown to wear would increase component lifetime significantly, and use of alumina ceramic material in the component areas not subject to wear would substantially reduce the overall cost.

For example, with the gas plasma injection nozzles used in semiconductor manufacturing, a small piece of sapphire may be used to make the orifice. The rest of the nozzle may be manufactured in alumina or aluminum nitride utilizing the manufacturing methods and costs already in use—without the orifice. The sapphire orifice is then bonded in place utilizing the aluminum brazing process described herein. In this way, the plasma erosion resistance of the sapphire is coupled with the manufacturability and cost of the original alumina nozzle.

In semiconductor manufacturing, high-energy gas plasma, which is both corrosive and high temperature is used to effect processing necessary in the making of integrated circuits. In many applications, components are used in the processing environment to contain and direct the plasma. Typically these components, commonly called edge rings, focus rings, gas rings, gas plates, blocker plates, etc., are made from quartz, silicon, alumina, or aluminum nitride. It is not uncommon for these components to have lifetimes measured in hours, as the erosion of the parts by the plasma causes process drift and contamination, requirement replacement of the components after short service times. In some applications, the plasma is injected into the processing environment by use of an array of ceramic nozzles. These nozzles are monolithic parts, with complex geometries, and with a small orifice on the order of 0.010″ diameter for controlling the flow rate and pattern of the plasma. Typical materials for these nozzles are aluminum oxide or aluminum nitride. Even with the use of these advanced ceramics, lifetime of the nozzles is 3 months due to erosion of the orifice by the high energy plasma. This requires that the machine be completely shut down every three months to replace the nozzle array, typically comprising more than 20 individual nozzles. While the nozzles are being eroded, they release contaminants into the plasma that reduce yields of the processing. And as the nozzles approach their end-of-life, the flow of the plasma begins to increase due to erosion of the orifice, which causes the process performance to change, further reducing yields. Other advanced ceramic materials have significantly lower erosion rates in that plasma environment, such as sapphire and yttrium oxide. If components such as edge rings and injector nozzles could be made with these materials, significant lifetime and performance improvements would result. However, due to the manufacturing and cost limitations mentioned above, no one uses such materials for this application. What is needed is a method to utilize the properties of the best materials with a cost near that of the current materials.

Aspects of the current invention provide a method to combine the properties of the best materials for erosion and corrosion such as sapphire (mono-crystalline aluminum oxide), yttrium oxide, and PSZ, with the lower cost advanced ceramic materials such as aluminum oxide. Utilizing methods according to embodiments of the present invention, which uses aluminum as a brazing material for joining advanced ceramic materials to themselves and other materials, it is now possible to join the properties of the highest performing advanced ceramic materials with the costs and manufacturability of the lower cost and simple manufacturability of ceramics such as alumina. Such processes produce joints with high levels of corrosion and erosion resistance, which can operate at elevated temperatures, and which can withstand significant variations in thermal expansion between the joined materials.

As part of the design of components as described above, the thermal expansion differentials of the ceramics will be reviewed. The thickness of the braze layer, and/or the thickness of the surface ceramic layer, may be selected to maintain stress levels during brazing and subsequent cooling, and during use, below allowable levels.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

What is claimed is:

1. A rotor shaft for a hydraulic fracturing system, said rotor shaft comprising:
a cylindrical pump shaft, said pump shaft comprising a first ceramic; a
an end cap over one end of said cylindrical pump shaft, said end shaft comprising a second ceramic; and
a joining layer joining said pump shaft and said end cap, said joining layer comprising metallic aluminum.

2. The rotor shaft of claim 1 wherein said cylindrical pump shaft further has a first diameter for much of its length, and a second diameter at one end, said second diameter smaller than said first diameter.

3. The rotor shaft of claim 1 wherein said end cap comprises a cylindrical shell, wherein the outer diameter of said end cap is said first diameter.

4. The rotor shaft of claim 3 wherein said end cap further comprises a circular end plate coupled to said cylindrical shell.

5. The rotor shaft of claim of claim 1 wherein said second ceramic comprises sapphire.

6. The rotor shaft of claim 3 wherein said second ceramic comprises sapphire.

7. The rotor shaft of claim 5 wherein said first ceramic comprises alumina.

8. The rotor shaft of claim 6 wherein said first ceramic comprises alumina.

9. The rotor shaft of claim 8 wherein said joining layer comprises greater than 99% metallic aluminum by weight.

10. The rotor shaft of claim of claim 1 wherein said second ceramic comprises MpPSZ.

11. The rotor shaft of claim 3 wherein said second ceramic comprises MpPSZ.

12. The rotor shaft of claim 10 wherein said first ceramic comprises alumina.

13. The rotor shaft of claim 11 wherein said first ceramic comprises alumina.

14. The rotor shaft of claim 13 wherein said joining layer comprises greater than 99% metallic aluminum by weight.

15. The rotor shaft of claim of claim 1 wherein said second ceramic comprises YTZ.

16. The rotor shaft of claim 3 wherein said second ceramic comprises YTZ.

17. The rotor shaft of claim 15 wherein said first ceramic comprises alumina.

18. The rotor shaft of claim 16 wherein said first ceramic comprises alumina.

19. The rotor shaft of claim 18 wherein said joining layer comprises greater than 99% metallic aluminum by weight.

20. An industrial component adapted for use in a highly erosive or corrosive environment, said industrial component comprising:
a structural support portion, said structural support portion having one or more identified high wear exposure surfaces;
one or more surface skins, said one or more wear surface layers joined to said one or more high wear exposure surfaces; and
one or more joining layers joining said structural support portion to said one or more wear surface layers,
wherein said joining layer comprises metallic aluminum.

21. The industrial component of claim 20 wherein said structural support portion comprises alumina.

22. The industrial component of claim 21 wherein said one or more surface layers comprise sapphire.

23. The industrial component of claim 21 wherein said joining layer comprises metallic aluminum of greater than 99% by weight.

24. The industrial component of claim 22 wherein said joining layer comprises metallic aluminum of greater than 99% by weight.

25. A method for the manufacture of an industrial component adapted for use in a highly erosive environment, said method comprising the steps of:
arranging one or more surface wear layers onto an industrial component main support structure with one or more brazing layers disposed between said one or surface wear layers and said support structure, said brazing layer comprising metallic aluminum;
placing the pre-brazing sub assembly into a process chamber;
removing oxygen from said process chamber;
removing oxygen from said process chamber; and
joining said surface wear layers to said main support structure by heating to a temperature of above 770C, thereby joining said surface wear layers to said main support structure with a hermetic joint.

26. The method of claim 25 wherein the step of removing oxygen from said process chamber comprises applying vacuum during the heating of the components to a pressure lower than 1×10E-4.

27. The method of claim 26 wherein said main support structure comprises aluminum nitride.

28. The method of claim 26 wherein said main support structure comprises alumina.

29. The method of claim 27 wherein said one or more surface layers comprise sapphire.

30. The method of claim 28 wherein said one or more surface layers comprise sapphire.

31. The method of claim 28 wherein said one or more surface layers comprises MpPSZ.

32. The method of claim 28 wherein said one or more surface layers comprises YTZ.

33. The method of claim 25 wherein said brazing layer comprises metallic aluminum of greater than 99% by weight.

34. The method of claim 30 wherein said brazing layer comprises metallic aluminum of greater than 99% by weight.

35. The method of claim 31 wherein said brazing layer comprises metallic aluminum of greater than 99% by weight.

36. The method of claim 32 wherein said brazing layer comprises metallic aluminum of greater than 99% by weight.
